(19) United States
(12) Patent Application Publication
(10) Pub. No.: US 2015/0074070 A1
(43) Pub. Date: Mar. 12, 2015

(54) SYSTEM AND METHOD FOR RECONCILING TRANSACTIONAL AND NON-TRANSACTIONAL OPERATIONS IN KEY-VALUE STORES

(71) Applicant: Yahoo! Inc., Sunnyvale, CA (US)

(72) Inventors: Edward Bortnikov, Haifa (IL); Eshcar Hillel, Haifa (IL); Artyom Sharov, Haifa (IL)

(73) Assignee: Yahoo! Inc., Sunnyvale, CA (US)

(21) Appl. No.: 14/022,069

(22) Filed: Sep. 9, 2013

(51) Int. Cl. G06F 9/46; G06F 17/30

(52) U.S. Cl. CPC G06F 9/466; G06F 17/30289
USPC 707/703

(57) ABSTRACT

Techniques are provided for detecting and resolving conflicts between native and transactional applications sharing a common database. As transactions are received at the database system, a timestamp is assigned to both the start and the commit time of a transaction, where the timestamps are synchronized with a logical clock in the database system. When the database system receives a native operation, the database system increments the time in the logical clock and assigns that updated time to the native operation. When the transaction is ready to commit, database system may determine conflicts between native and transactional operations. If the database system determines that a native operation conflicts with a transactional operation, database system will abort the transaction.

### FIELD OF THE INVENTION

The present invention relates generally to database systems and more particularly database systems that are capable of processing both native and transactional database operations while maintaining data consistency.

### BACKGROUND

Modern internet applications have increased the demand for a scalable database. Applications such as an online personalized recommendation service might require a database that stores and maintains profile for each and every one of its millions of unique users. Traditional SQL databases do not scale well with those requirements. Accordingly, a new generation of not-only-SQL databases, or NoSQL databases were developed to meet the requirements of modern internet applications.

NoSQL databases are designed for extreme simplicity (key-value store API), scalability (data partitioning across multiple machines) and reliability (redundant storage and fault tolerant metadata services). To provide data consistency, some NoSQL databases support traditional database mechanisms such as transactions, where multiple read and write operations are bundled into atomic durable units.

Unfortunately, data inconsistency issues can surface when a NoSQL database is shared by both transactional applications and native applications due to the different consistency semantics between the native and transactional operations. Specifically, data consistency is not preserved when a native write operation conflicts with transactional read or write operations, or when a native read operation is exposed to uncommitted data from transactional write operations.

For example, in a mobile-commerce recommendation system, users may check-in on their mobile device in order to receive personalized recommendations of local businesses or deals based on the user's location. The database used by such a recommendation system may be accessed by both users' mobile devices and a recommendation service that provides the list of recommendations based on the user's location. The mobile device writes the user's location natively to the database to ensure that the database will always have the most up-to date user location, and reads from the database natively to retrieve the current recommendation. The recommendation service runs in background, computes recommendations for multiple users in a batch, and writes the recommendations to the database. It requires reading and writing data to multiple database records, and therefore employs transactions to read and write data to the database.

Typically, such a mobile application signals the recommendation service by raising a “re-compute request” persistent flag following a location update. The recommendation service writes the new recommendation and resets the request flag. In this context, if a user updates his or her current location concurrently with the process of writing recommendations computed based on user′ previous location, the recommendation service may write stale recommendations to the database, and reset the request flag This causes the user to receive outdated recommendations after the user updates his or her current location. In addition, the recommendations remains stale indefinitely because the request flag has been reset.

Another data inconsistency issue arises when a user attempts to read a set of recommendations that has not yet been committed. This is an example of a conflict between a native read operation and transactional write operations. In a typical transactional database system, transactional write operations write the new values in the database prior to commit. The new values are easily readable by other concurrent transactions. The new values are finalized when the database receives the commit command. If the database receives an abort command, the database will roll back all of the new values written by the transaction. In the context of the above mobile-commerce recommendation system, if a user employs a non-transactional read to retrieve a list of recommendations written by a transaction before that transaction is committed, then the user may be exposed to invalid recommendations if that transaction is later aborted.

One possible approach to resolve the data inconsistency issues described above is to force the database system to only support transactional operations. In this approach, native operations are converted to transactions and any conflict between the converted “transactions” and regular transactions are resolved using well known transactional conflict resolution mechanisms. This approach ensures that atomicity is enforced everywhere, and that data used by one operation is not corrupted by another operation. However, this approach does not take into account the needs or demands behind modern internet applications such as the one detailed above, in which user's location should be updated with minimum latency, so that the user will receive the most up-to date list of recommendations. Converting the user location update as a transactional operation is undesirable due to transactional overheads and wait time.

Another possible approach is to write custom application logic that separates the data used by native applications and the data used by transactional applications. This approach is often cumbersome, complex, and may result in excess overhead when trying to maintain data consistency.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an example database system environment upon which an embodiment may be implemented.

FIG. 2 depicts an example of detecting conflicts between native and transactional operations using timestamps.

FIG. 3 illustrates an example method of resolving conflict between native and transactional operations.

FIG. 4 is a block diagram of a computer system on which techniques of the present disclosure could be implemented.

### DETAILED DESCRIPTION

The following description sets forth embodiments for a database system that supports both native and transactions operations while maintaining data consistency. However, this description should not be interpreted as limiting the use of the embodiments to any one particular application or any one particular type of data processing system. Rather, the embodiments may be utilized for a variety of different applications and in a variety of different contexts including database systems generally or any other system or application in which maintaining data consistency may be useful.

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system is provided which accommodates both the transactional and the native API's in a single database. The system employs various techniques to guarantee data safety, and can be tailored to support serializable and/or snapshot isolation consistency semantics.

In general, native operations are protected from reading dirty data (uncommitted changes made by transactional operations) by delaying the transactional write operations until commit. In addition, conflicts between the native write operations and transactions are resolved by allowing the native write operations to complete and aborting the transactions.

According to one embodiment, the system maintains consistency between data items based on timestamps. However, when the data is distributed across multiple database servers, the logical clocks used by the database servers may be out of sync with each other. Consequently, the timestamps assigned by one database server may not be ordered correctly relative to the timestamps assigned by another database server.

To address this problem, a timestamp synchronization protocol is described hereafter to ensure that the various database servers assign timestamps that are ordered, relative to each other, in a way that preserves consistency.

### Operational Overview

In one embodiment, a transactional client:

sends a begin transaction command,

sends multiple read and write operations, and

sends a commit command.

In one embodiment, a database that is communicatively coupled to the transactional client does not support transactions completely. The transaction processing system (aka “mediator”) processes the transactional client's begin and commit commands. The mediator guarantees the correctness of read and write (aka datapath) commands, which the client executes directly to the database.

In one embodiment, a transactional client reads directly from the database system, but buffers the writes locally until commit. When the client application requests commit of the transaction, it sends the mediator system a collection of keys it has changed (aka write set). The mediator system responds by checking for conflicts between (1) the transaction and any concurrent transactions, and (2) the transaction and any native operations. If no conflicts exist, the mediator system performs the requested write operations, and commits the changes made by the transaction to the database.

### System Overview

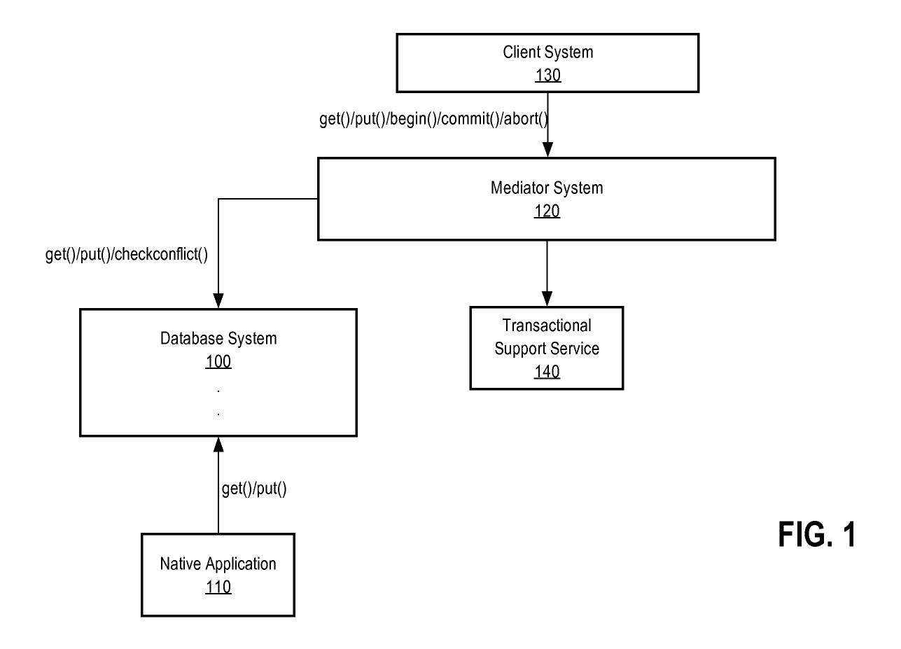

FIG. 1 illustrates an example system that supports both native and transactional operations. Referring to FIG. 1, database system 100 is communicatively coupled to native application 110 and mediator system 120. Database system 100 includes a database server and one or more storage devices (not separately shown).

Database system 100, native application 110 and mediator system 120 may be executing on separate computers or on the same computer. In one embodiment, database system 100 is a database system configured with a key-value store and interfaces for get( ) and put( ) operations. A get( ) operation specifies the key of the data item to read, and returns the value read by the operation. A put( ) operation specifies the key and a value to be written to the database. In one embodiment, native application 110 may use the interfaces for get( ) and put( ) operations to read or write data directly to database system 100.

In addition to native operations, database system 100 implements interfaces for transactional operations. In one embodiment, the interfaces for transactional operation include a conflictcheck( ) operation in addition to the transactional get( ) and put( ) operations. The conflictcheck( ) operation checks for conflicts between native and transactional operations at the end of a transaction, as shall be explained in greater detail hereafter. In one embodiment, mediator system 120 may not be aware that database system 100 is executing native database operations sent from native application 100.

Database system 100 is configured for multi-version concurrency control to implement the different consistency models. In one embodiment, database system 100 is configured to support a snapshot isolation model for transactions, in which each transaction observes a snapshot of database system 100 based on the state of database system 100 at the moment in time when the transaction begins. In addition, database system 100 may also be configured to support a serializability model for transactions, with which each transaction can be logically linearized into a single point in time.

### Mediator Operations

In the embodiment illustrated in FIG. 1, mediator system 120 is connected to a client system 130 and a transactional support service 140. In one embodiment, mediator system 120 is configured with interfaces for begin( ) commit( ) and abort( ) operations in addition to the get( ) and put( ) operations.

A begin( ) operation initializes a transaction. A commit( ) operation signals the end of the transaction and may return an indication whether the transaction was committed or aborted. An abort( ) operation cancels the corresponding transaction.

In one embodiment, mediator system 120 receives one or more get( ) operations from the client system 130 after mediator system 120 executes the begin( ) operation to start a transaction. In response to receiving the get( ) operations from client system 130, mediator system 120 retrieves the values associated with the keys from database system 100 using transactional get( ) operations. In one embodiment, the transactional get( ) operations may return the last committed value for a specific key. In another embodiment, the transactional get( ) operations may return the most recent value for a specific key.

In one embodiment, mediator system 120 receives one or more put( ) operations from client system 130 after mediator system 120 executes the begin( ) operation to start a transaction. The transactional put( ) operations are not immediately executed. Rather, the put( ) operations are stored locally at mediator system 120. The operations may be stored, for example, as a table recording, for each item involved in the put( ) operation, the key and its new value.

When mediator system 120 receives a commit( ) operation from client system 130, mediator system 120 responds by writing the new values to their associated keys in database system 100 using the transactional put( ) operations.

If mediator system 120 receives an abort( ) operation from client system 130, mediator system 120 responds to the abort operation by discarding the locally stored table that contains the keys and their associated values from the put( ) operations received from client system 130. In one embodiment, mediator systems 120 may receive a mix of get( ) and put( ) operations from client system 130. Mediator system 120 executes the get( ) operations first, and executes the put( ) operations upon commit.

### Conflict Checks

As mentioned above, in response to receiving a commit command, the database server runs a conflict check operation. In one embodiment, the conflict check operation checks for potential conflicts between native and transactional operations.

Specifically, the database server may determine that a conflict occurred between a transactional write to an item and a native write to the same item when the native write operation was executed between the start and the end of the transaction.

As another example, the database may determine that a conflict occurred between a transactional read of an item and a native write of the same item when the native write operation was executed between the start and the end of the transaction.

In response to determining that a conflict exists, the database aborts the transaction. If the database system determines that there are no conflicts between the native operations executed by the database and the operations that belong to the transaction, then the database may commits the changes made by the write operations that belong to the transaction.

Referring again to FIG. 1, when conflictcheck( ) is called for a particular transaction, database system 100 determines conflicts between native operations and the operations performed by that particular transaction. Database system 100 starts the conflict determination process in response to receiving indication that a transaction is ready to commit on database system 100.

As mentioned above, database system 100 may determine a conflict exists if a native put( ) operation executed after the start of the transaction and a transactional put( ) operation both write conflicting values to the same key in database system 100. In response to determining that there is a conflict, database system 100 may abort the transaction and preserve the value written by the native put( ) operation.

In addition, database system 100 may determines a conflict exists if a transactional get( ) operation reads a value from a specific key in database system 100 and a native put( ) operation has written a value to that specific key in database system 100 between the start and the end of a transaction. In response to determining that there is a conflict, database system 100 aborts the transaction.

### Delayed Put( ) Operations

As mentioned above, mediator system 120 delays writing data to database system 100 until mediator system 120 receives a commit( ) command from client system 130. This timing prevents conflicts between native get( ) operations and transactional put( ) operations. If the transactional put( ) operations were not delayed until commit, then a native get( ) operation may read and return a value written by a transactional put( ) operation where that transaction may be aborted at a later time. By delaying the writes to database system 100, this ensures that native get( ) operations only read and return values from database system 100 that have been fully committed and not aborted.

### Timestamps

The conflict checks mentioned above are performed based on timestamps that are assigned to the various events that occur within the database system. Typically, such timestamps are obtained from a logical clock maintained by the database server. However, when multiple database servers and a central transaction processing system are involved, a synchronization protocol must be used to ensure that the timestamps assigned to events are consistent across all database systems.

According to one embodiment, the protocol includes:
At the beginning of a transaction, the transaction processing service assigns a transaction timestamp to the transaction-enabled client that is starting the transaction. These timestamps may be incremented in big jumps (e.g., 2̂20).
Causing the transaction-enabled clients to piggyback their assigned timestamp on their get/put requests to the database servers.
Each database server, upon receiving the transaction timestamp that is piggybacked on a get/put request, promotes its internal logical clock to the received value. That is, if the logical clock timestamp is less than that of the piggybacked timestamp, then the logical clock timestamp is set to the piggybacked timestamp.
Independently of the above actions relating to transactional operations, the native updates performed by the database servers are stamped by the local logical clock, independently at each database server. Upon performing a native update operation, the clock of each database server is incremented by 1.

Following this protocol ensures that (a) each transaction will be assigned a start time that is greater than the timestamps of any preceding native updates, and (b) all native updates made in a given database system after a transaction has interacted with the database system will have timestamps that are greater than the start time of the transaction.

### Transaction Descriptors

In one embodiment, mediator system 120 is configured to maintain a list of active transactions, with which the data of each transaction is stored in a transaction descriptor. The transaction descriptor may store a “read set”, a “write set”, and timestamps that correspond to the start and end of a transaction. In one embodiment, the read set stores the values returned from the transactional get( ) operations that were sent from mediator system 120 to database system 100. The write set stores the keys and their associated values from the put( ) operations received from client system 130.

### Transactional Support Service

In one embodiment, mediator system 120 is connected to a transactional support service 140. Transactional support service 140 generates and assigns timestamps, described above, to the start and the end of the transactions that mediator system 120 receives from client system 130.

In one embodiment, the timestamps assigned to the start and the end of a transaction are sent along with the transactional operations from mediator system 120 to database system 100.

In one embodiment, in response to receiving the start of a transaction and the assigned timestamp, database system 100 uses the timestamp assigned to the start of the transaction to advance the server's logical clock, thereby creating a “temporal fence”. The temporal fence ensures that the forthcoming native commands do not violate the transaction's consistency.

In one embodiment, database system 100 assigns a timestamp based on its logical clock to any native get( ) or put( ) operations that database system 100 has received. The logical clock and the temporal fence are used to determine conflicts between native database operations and transactional database operations.

### Example of Temporal Fence and Timestamp Usage

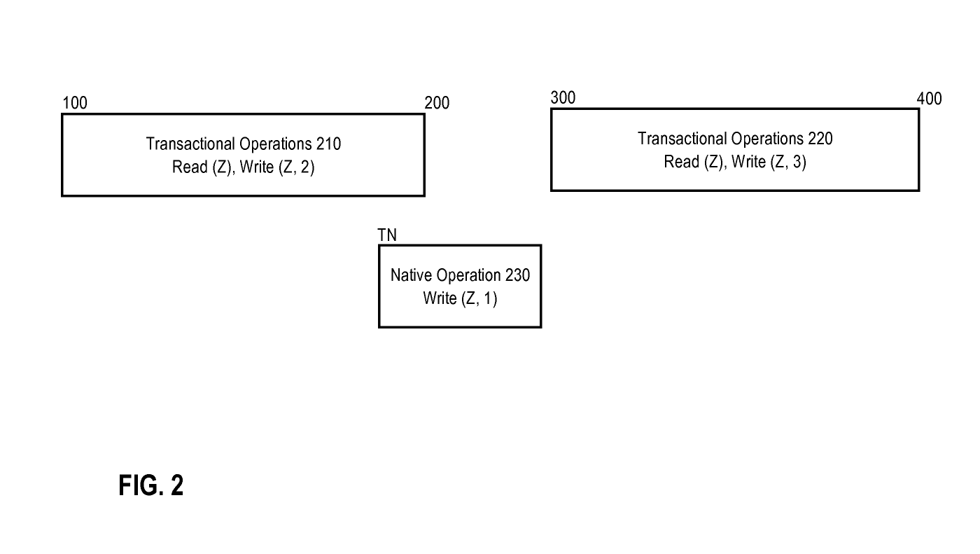

FIG. 2 illustrates an example of using timestamps to maintain data consistency using the techniques described herein. The consistency model used in this example is snapshot isolation.

In the example, database system 100 receives a transactional operation 210 that has been assigned a start time of 100. Transactional operation 210 involves two database operations: reading the value of Z, and writing the value of 2 to Z. Transactional operation 210 commits at time of 200.

A separate transactional operation 220 starts at a later time 300. Transactional operation 220 reads the value of Z, writes the value of 3 to Z and is finally committed at time of 400.

Assuming that database system 100 starts with the value of 0 for Z and only receives the transaction operations, transactional operation 210 would return a value of 0 for Z, and then write the value of 2 to Z. Transactional operation 220 would return a value of 2 for Z, and then write the value of 3 to Z.

In addition to the two transactional operations, database system 100 may also receive a native operation 230. Native operation 230 may originate from native application 110 and therefore may not access transactional support service 140 to receive a timestamp. Instead, native operation 230 obtains its timestamp from the logical clock of database system 100. The native operation 230 writes the value of 1 to Z, and native operation 230 is executed at an unknown time TN.

In one embodiment, native operation 230 may potentially conflict with the transactional operations 210 and 220, depending on when native operation 230 is executed. For example, if native operation 230 is executed after transactional operation 210 has interacted with database system 100, then database system 100 would have assigned native operation 230 a timestamp that is after the time of 100 but before the time of 200. Under these conditions, transactional operation 210 overlaps with native operation 230 and both operations are writing conflicting values to Z.

On the other hand, if native operation 230 is executed after the transactional operation 220 has interacted with the database, but before transactional operation 220 has committed, then native operation 230 will be assigned a time that is after 300 but before 400. Under these circumstances, transactional operation 220 and native operation 230 overlap, and both operations are writing conflicting values to Z.

In order to detect and resolve the above conflicts, database system 100 employs a temporal fence, as described above. Specifically, at the start and at the end of each transaction, transactional support service 140 assigns a timestamp to the start and the end of each transaction. The logical clock on database system 100 is bumped up to those values when the transactions interact with the database system 100. For example, when transactional operation 210 first interacts with database system 100, the timestamp of 100 (which is piggybacked on the request) is used to update the logical clock on database system 100. Likewise, when transactional operation 210 commits the operations of transaction operation 210 to database system 100, the logical clock on database system 100 is bumped up to the commit timestamp of 200. Accordingly, a temporal fence is created from logical clock time of 100 to 200. Transactional operation 220 will also create a temporal fence from logical clock time of 300 to 400.

In one embodiment, if database system 100 receives any native transactions between time of 100 and 400, database system 100 assigns a time to the native transaction using the current value of its logical clock. Database system 100 then increments the logical clock by a small amount.

For example, if native operation 230 was executed at some point after logical clock time of 100, database system 100 may assign a time of 101 to native operation 230 to indicate that native operation 230 was executed at some point after the start of transactional operation 210. In one embodiment, after transactional operation 210 successfully commits, the logical clock of database system 100 is synchronized to a time of 200. If database system 100 receives a native operation shortly after, but before transactional operation 220 starts, database system 100 may assign a time of 201 to received native operation. In one embodiment, the increment to the logical clock is small enough so that each native operation will have its own unique timestamp and that the timestamps assigned to the native operations do not conflict with timestamps assigned by the transactional support service 140.

In the case that native transaction 230 is assigned a time of 101, when transactional operation 210 attempts to commit, the logical clock on database system 100 is bumped up to commit time 200. In addition, in response to receiving the commit operation and its timestamp, database system 100 checks for conflicts between native operations and the transaction that is attempting to commit. In this case, database system 100 would determine that a native operation (native operation 230) was executed between the start and the end of transactional operation 210, since the time assigned to native operation 230 is bigger than the begin transaction timestamp and smaller than the commit timestamp. Furthermore, both native operation 230 and transactional operation 210 are writing different values to Z. Database system 100 thus determines that this is a case of write-write conflict.

In response to determining the write-write conflict, database system 100 aborts transactional operation 210. In this instance, Z will have value of 1 after transactional operation 210 is aborted.

In the case that native operation 230 is assigned a time of 201, when transactional operation 210 attempts to commit, database system 100 would determine that there are no conflicts. The value of Z becomes 2 after transactional operation 210 commits, after which native operation 230 updates the value of Z to 1. Transactional operation 230 would return value of Z as 1 before writing the value of 3 to Z.

### Summary of an Overall Methodology

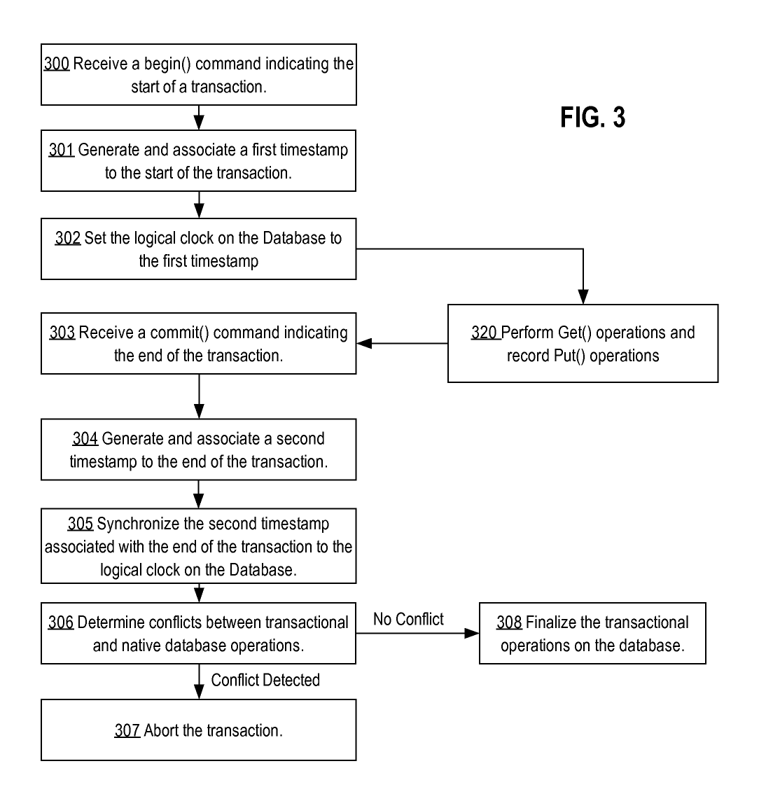

FIG. 3 provides a summary of an overall methodology that detects and resolves conflicts between native and transactional operations. The methodology is primarily described with reference to the flowchart of FIG. 3. Each block within the flowchart represents both a method step and an element of an apparatus for performing the method step. For example, in an apparatus implementation, a block within a flowchart may represent computer program instructions loaded into memory or storage of a general-purpose or special-purpose computer.

Depending upon the implementation, the corresponding apparatus element may be configured in hardware, software, firmware, or combinations thereof. For the purpose of explaining a clear example, the following description assumes that the process depicted by FIG. 3 is implemented by a combination of database system 100, native application 110, mediator system 120, client system 130 and transactional support service 140. In other embodiments, the broad techniques shown in FIG. 3 may be implemented in other functional units.

At block 300, mediator system 120 receives a begin( ) operation from client system 130 indicating the start of a transaction.

At block 301, in response to receiving the begin( ) command, mediator 120 may send a request for a first timestamp to transactional support service 140. In response to receiving the request for a first timestamp, transactional support service 140 may generate a first timestamp and send it to mediator 120. The first timestamp is then associated with the start of the transaction.

At block 302, the logical clock on database system 100 is bumped up to the first timestamp in response to the transaction interacting with the database system 100. After block 302, control proceeds to block 320. At block 320, the get( ) operations required by the transaction are performed, while the put( ) operations are recorded (e.g. in a structure that is separate from structure in which the targeted items durably reside) but not performed.

For example, at block 320, as part of the transaction, mediator system 120 may execute one or more transactional get( ) operations on database system 100. In one embodiment, the timestamp associated with the start of the transaction is sent along with the transactional get( ) operations. In one embodiment, the result of transactional get( ) operations are returned to a read set stored on the mediator system 120. In another embodiment, mediator system 120 may store a write set containing the keys and the updated values resulting from the one or more put 0 operations within the transaction.

At block 303, mediator system 120 receives a commit( ) command indicating the end of the transaction. At block 304, in response to receiving the commit( ) command, mediator 120 sends a request for a second timestamp to transactional support service 140. In response to receiving the request for a second timestamp, transactional support service 140 generates a second timestamp and sends it to mediator 120. The second timestamp is then associated with the end of the transaction.

At block 305, the second timestamp that is associated with the end of the transaction is synchronized with the logical clock on database system 100, causing the logical clock to be bumped up to the end-of-transaction timestamp.

At block 306, in response to receiving commit( ) command, database system 100 runs a conflict check operation to determine if there are any conflicts between the native operations and transactional operations. In one embodiment, database system 100 checks for a native operation that has a timestamp indicating that the native operation was executed by database system 100 between the start and the end of the transaction.

In one embodiment, if there is a native operation with the timestamp indicating the native operation was executed by database system 100 between the start and the end of the transaction, database system 100 will then look at the individual read and write operations within the transaction and the native operation to determine if there is a conflict. In one embodiment, a conflict is detected when the native operation and a transactional write operation write conflicting value to database system 100. In another embodiment, a conflict is detected when the native operation has updated a value in database system 100 that a transactional read operation has already read. If database system 100 determines that there is no conflict, then control proceeds to block 308. Otherwise, database system 100 has determined that there is a conflict and such embodiment proceeds to 307.

At block 307, in response to determine that there is a conflict between a native operation that was executed between the start and the end of the transaction and one or more transactional operations within the transaction, database system 100 aborts the transaction. In one embodiment, in response to aborting the transaction, mediator system 120 deletes the read set, the write set and the timestamps associated with the transaction.

At block 308, in response to determining that there is no conflict, the one or more transactional operations are finalized on database system 100. In one embodiment, in response to determining that there is no conflict between native and transactional operations, mediator system 120 sends the keys and values associated with the transaction from its write set to database system 100 using the transactional put( ) operation.

Before receiving a commit command, mediator system 120 receive an abort( ) command. As mentioned above, in response to receiving the abort( ) command, mediator system 120 cancels the current transaction. In addition, mediator system 120 deletes the data in its current read and write set that originates from the aborted transaction.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

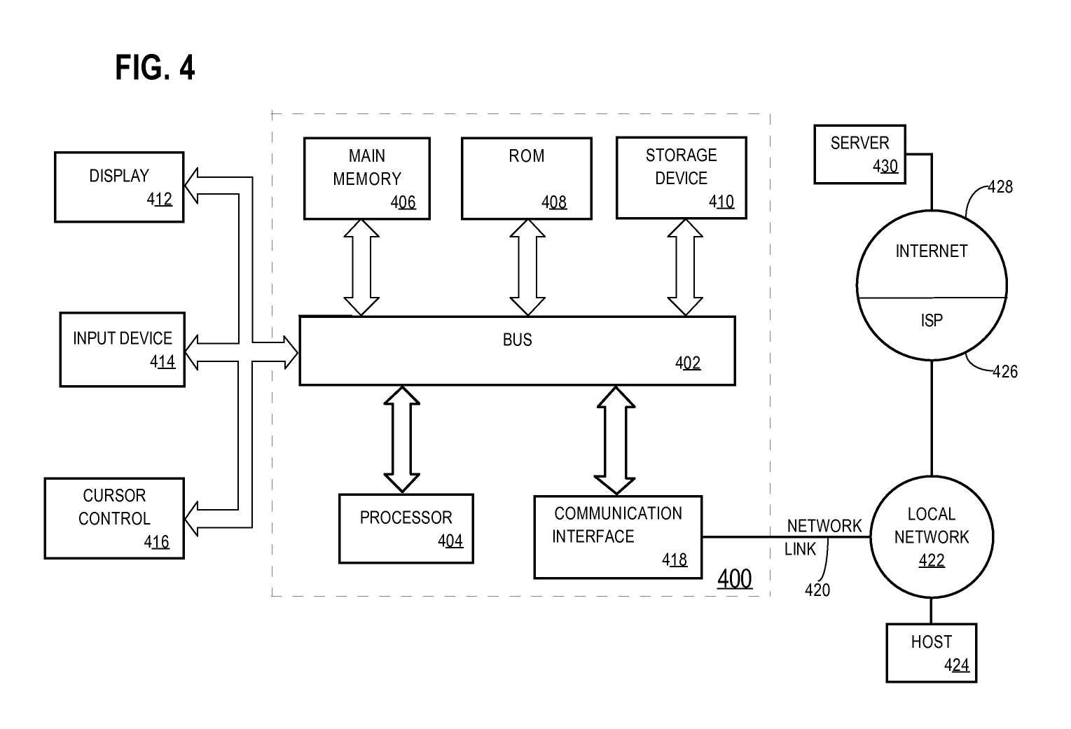

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing, in a database system, data that is accessible to both transaction-enabled clients and native clients;
executing a transaction initiated by a transaction-enabled client, by:
performing read operations that belong to the transaction; and
delaying performance of write operations that belong to the transaction;
while the transaction is executing, allowing native clients to perform operations on items managed by the database system;
in response to a request to commit the transaction, determining whether any conflict exists between the transaction and any native database operation performed by the database system during execution of the transaction;
wherein determining whether any conflict exists includes determining whether a native database operation, executed by the database system between the start and the end of the transaction, wrote to an item that was read by or will be written to by the transaction;
responsive to determining that a conflict exists, aborting the transaction;
responsive to determining that no conflict exists, performing the write operations that belong to the transaction and committing the transaction;
wherein the method is performed by one or more computing devices.

2. The method of claim 1 further comprising:
maintaining a logical clock for the database system;
assigning a start time to the transaction;
including the start time with requests, to the database system, to perform the read operations that belong to the transaction;
causing the database system to update the logical clock to the start time if the start time is greater than the current time of the logical clock.

3. The method of claim 2 further comprising assigning timestamps to native update operations, performed by the database system, based on the logical clock.

4. The method of claim 3 wherein determining whether any conflict exists is performed based, at least in part, on comparing the start time of the transaction to the timestamps assigned to native operations that updated any item that was read by or will be written to by the transaction.

5. The method of claim 1 wherein delaying the write operations involves storing, at a mediator system that resides between the transaction-enabled client and the database system, data that indicates keys of items to be changed, and values to which the items are to be changed.

6. The method of claim 1 wherein:
the database system is one of a plurality of database systems, each of which maintains its own logical clock for assigning timestamps to native operations;
a start time is assigned to the transaction;
in response to performing an operation for the transaction in any one of the plurality of database systems, causing the database system to update its respective logical clock to the start time if the logical clock is currently less than the start time.

7. The method of claim 2 further comprising:
in response to the request to commit the transaction, assigning an end time to the transaction;
sending the end time to the database system;
causing the database system to update the logical clock to the end time if the end time is greater than the current time of the logical clock.

8. A non-transitory computer-readable medium storing instructions which, when executed by one or more processors, cause performance of a method comprising the steps of:
storing, in a database system, data that is accessible to both transaction-enabled clients and native clients;
executing a transaction initiated by a transaction-enabled client, by:
performing read operations that belong to the transaction; and
delaying performance of write operations that belong to the transaction;
while the transaction is executing, allowing native clients to perform operations on items managed by the database system;
in response to a request to commit the transaction, determining whether any conflict exists between the transaction and any native database operation performed by the database system during execution of the transaction;
wherein determining whether any conflict exists includes determining whether a native database operation, executed by the database system between the start and the end of the transaction, wrote to an item that was read by or will be written to by the transaction;
responsive to determining that a conflict exists, aborting the transaction;
responsive to determining that no conflict exists, performing the write operations that belong to the transaction and committing the transaction.

9. The non-transitory computer-readable medium of claim 8 wherein the method further comprises:
maintaining a logical clock for the database system;
assigning a start time to the transaction;
including the start time with requests, to the database system, to perform the read operations that belong to the transaction;
causing the database system to update the logical clock to the start time if the start time is greater than the current time of the logical clock.

10. The non-transitory computer-readable medium of claim 9 wherein the method further comprises assigning timestamps to native update operations, performed by the database system, based on the logical clock.

11. The non-transitory computer-readable medium of claim 10 wherein determining whether any conflict exists is performed based, at least in part, on comparing the start time of the transaction to the timestamps assigned to native operations that updated any item that was read by or will be written to by the transaction.

12. The non-transitory computer-readable medium of claim 8 wherein delaying the write operations involves storing, at a mediator system that resides between the transaction-enabled client and the database system, data that indicates keys of items to be changed, and values to which the items are to be changed.

13. The non-transitory computer-readable medium of claim 8 wherein:
the database system is one of a plurality of database systems, each of which maintains its own logical clock for assigning timestamps to native operations;
a start time is assigned to the transaction;
in response to performing an operation for the transaction in any one of the plurality of database systems, causing the database system to update its respective logical clock to the start time if the logical clock is currently less than the start time.

14. The non-transitory computer-readable medium of claim 9 wherein the method further comprises:
in response to the request to commit the transaction, assigning an end time to the transaction;
sending the end time to the database system;
causing the database system to update the logical clock to the end time if the end time is greater than the current time of the logical clock.

15. A system comprising:
a mediator system, executed by one or more processors;
a transaction-enabled client operatively coupled to the mediator system;
a database system operatively coupled to the mediator system, wherein the database system includes a database server and one or more storage devices;
wherein the database system includes a native interface and a transactional interface;
wherein the mediator system is configured to:
receive a first request to start a transaction for the transaction-enabled client;
respond to the request by:
performing read operations that belong to the transaction; and
delaying performance of write operations that belong to the transaction;
receive a second request to commit the transaction;
respond to the second request by performing the steps of:
causing the database system to determine whether any conflict exists between the transaction and any native database operation performed by the database system during execution of the transaction;
responsive to determining that a conflict exists, causing the database system to abort the transaction;
responsive to determining that no conflict exists, performing the write operations that belong to the transaction and causing the database system to commit the transaction;
wherein the database server allows native clients to perform operations on items managed by the database system while the transaction is executing.
